(19) United States
(12) Patent Application Publication
(10) Pub. No.: US 2011/0003076 A1
(43) Pub. Date: Jan. 6, 2011

(54) Scenting Process

(76) Inventor: Paul Benton Tarnopol, Coconut Grove, FL (US)

Correspondence Address: ANDREWS KURTH LLP, 1350 I STREET, N.W., SUITE 1100, WASHINGTON, DC, 20005, US

(21) Appl. No.: 12/458,156

(22) Filed: Jul. 1, 2009

(51) Int. Cl. B05D 5/00

(52) U.S. Cl. 427/288; 427/256

(57) ABSTRACT

A method for manufacturing scented material. The method includes selecting one or more scented oils to use for scenting a material, micro-encapsulating the selected one or more scented oils, suspending the micro-encapsulated one or more scented oils into a liquid medium, and applying ink to the material. An ink layer is formed on the material. The method further includes applying the liquid medium with the micro-encapsulated one or more scented oils to the material on top of the ink layer. A scented layer is formed above the ink layer on the material.

### BACKGROUND

Scent is often used on printed material that may be incorporated into products, packaging or advertising. The scent is often used to attract customers through the sense of smell, providing an additional sensory stimulus beyond the visual. So called “scratch-n-sniff” scents are common and have been used in packaging, advertising and products.

One common method of providing scent in printed materials utilizes micro-capsulation. Scented oils or other materials that provide a scent are encapsulated in microcapsules. See, e.g., WO 2007/009023A2. The scented microcapsules are then mixed into the ink that is used to print the printed material or otherwise applied to the product, packaging or advertising. The ink with the microcapsules is then printed or applied.

To release the microencapsulated scent, the dried ink with the microcapsules is scratched, touched or similarly abraded. The scratching breaks or ruptures the microcapsules containing the scented oils, releasing the oils into the air and providing the scent. The dried ink will continue to provide the scent as long as it still contains un-ruptured microcapsules.

There are a number of significant disadvantages of the current method of scenting described above. One of these disadvantages is that the current method requires the dried ink to be constantly abraded to release the scent. As described above, since the microcapsules are in the ink, the ink is scratched or abraded to rupture the microcapsules and release the scent. The constant abrasion of the dried ink wears out the ink, distorting and even removing the image, the colors and/or text that were printed with the ink.

Additionally, mixing the microcapsules into the ink can dilute the vibrant colors of the ink. In other words, compared to printed material printed with ink without microcapsules, printed material printed with the ink with the microcapsules will necessarily have less ink for the same surface area. This results in necessarily less vibrant colors or otherwise duller printing.

### SUMMARY

A method for manufacturing scented material. The method includes micro-encapsulating one or more scented oils, suspending placing the micro-encapsulated one or more scented oils into a liquid medium and applying ink to the material. An ink layer is formed on the material. The method further includes applying the liquid medium with the micro-encapsulated one or more scented oils to the material on top of the ink layer. A scented layer is formed above the ink layer on the material.

A method for manufacturing scented material. The method includes selecting one or more scented oils to use for scenting a material and micro-encapsulating the selected one or more scented oils. The micro-encapsulating forms a plurality of scented oil micro-capsules, the micro-capsules containing scented oil. The method also includes applying ink to the material, applying the micro-capsules to the material on top of the ink layer, drying the material and preparing the scented material for an intended use.

### DESCRIPTION OF THE DRAWINGS

The detailed description will refer to the following drawings, wherein like numerals refer to like elements, and wherein:

FIG. 1 is a flowchart of an embodiment of a method for manufacturing scented material.

FIG. 2 is a cross-section diagram of a scented material manufactured according to an embodiment of a method for manufacturing scented material.

### DETAILED DESCRIPTION

Described herein are embodiments of methods for manufacturing scented material and scented material manufactured according to same. The embodiments described herein provide a novel process of applying scent to printed or other material. One novel aspect of embodiments described herein is that the microencapsulated scents are applied as a separate layer, e.g., as a varnish, on top of the colored inks. In this manner, many of the disadvantages of the prior methods are overcome. For example, the vibrant colors of the inks do not become diluted by the presence of microcapsules, which were previously mixed into the ink. Moreover, image, print or colors created by the ink do not become distorted as the microcapsules are released scratching, touching or other abrasion.

Additionally, the embodiments described herein provide a number of other advantages. For example, more of the scented microcapsules are exposed to the outside of the printed or other material than previously possibly, which will result in more scent being released into the surrounding atmosphere. When the microcapsules are mixed into the ink, as in prior methods, the amount of microcapsules that can be released is reduced.

As used herein, micro-encapsulation or micro-capsulation, and related forms of these words, refer to the process of forming micro-capsules (e.g., of a scented oil or oils).

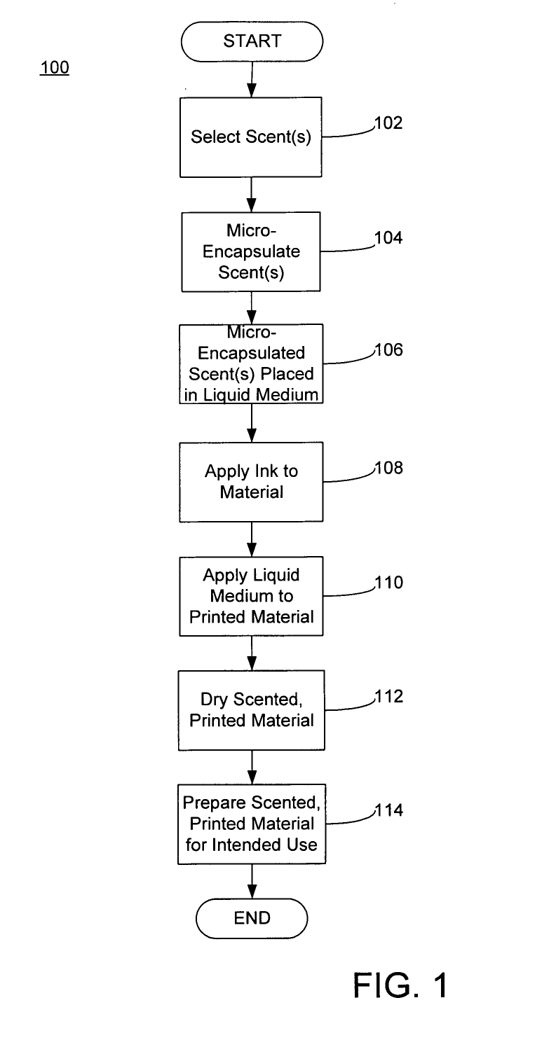

With reference now to FIG. 1, shown is a flow diagram illustrating an embodiment of method 100 for manufacturing scented materials. Scented oil or scented oils are selected, block 102. The scented oils are selected to provide the desired scent. The scent may be provided by a single scented oil or a combination or blend of scented oils. The scented oils may be specifically manufactured for the desired scent or scents. Numerous scents may be provided, including without limitation scents of: lavender, cherry, peach, apple, mango, coconut, evergreen, rosewood, apple cider, kiwi, guava, strawberry, banana, citrus, etc. Various companies produce and sell scented oils that may be used, including, for example, Andrea Aromatics and Wellington Fragrance.

Once the scented oil or oils is selected, the oils are microencapsulated, block 104. The oils are put through the micro-capsulation process to essentially create microscopic capsules of the selected oil or oils. The microscopic capsules, or microcapsules, are very small (e.g., approximately thirty (30) microns in diameter)) and thin. The microcapsules are designed to rupture when touched (e.g., the scratching or other abrasive force mentioned above). Once ruptured, the scent of the microencapsulated oil is released in the air creating an aroma of the scent.

The process of micro-capsulation is known to one of skill in the art. See, e.g., WO 2007/009023A2. In an embodiment, the micro-capsulation process surrounds tiny droplets of the scented oils with a coating, creating the microcapsules and, in the process, giving the microcapsules many useful properties. In a relatively simplistic form, a microcapsule is a small cylinder or sphere with a relatively uniform wall around it. The material inside the microcapsule is referred to as the core, internal phase, or fill, whereas the wall is sometimes called a shell, coating, or membrane. Many microcapsules however bear little resemblance to these simple spheres. The core may be a crystal, a jagged adsorbent particle, an emulsion, a suspension of solids, or a suspension of smaller microcapsules. The microcapsule may even have multiple walls. Most microcapsules have diameters between a few micrometers and a few millimeters.

There are many known methods of micro-capsulation. For example, there are physical methods including the pan coating, air-suspension, centrifugal extrusion, vibrational nozzle and spray-drying methods. There are also chemical methods, including the interfacial polymerization, in-situ polymerization and matrix polymerization methods. One of skill in the art is familiar with these methods.

With continuing reference to FIG. 1, in an embodiment, the micro-encapsulated scented oils (i.e., the scented oil micro-capsules) are suspended pr [;aced in a liquid medium, block 106. For example, the he micro-encapsulated scented oils may be placed into a water-based slurry with a binder In an embodiment, the slurry is micro-capsules, water and binder. The amount or percentage of micro-capsules may be diluted in the slurry to a variety of dilutions depending on a variety of factors, including how much micro-capsules are desired to be applied, how strong a scent is desired, etc. In an embodiment, the micro-capsules make up approximately thirty-five percent (35%) of the slurry (e.g., by volume). The slurry may include more or less micro-capsules, e.g., by volume. The binder binds to the micro-capsules and functions as an adhesive causing the micro-capsules to stick or adhere to the material (e.g., the printed material) in the below-described printing process. The binder may be any binder capable of adhering to the micro-capsules and causing micro-capsules to adhere to the material. The binder may be, for example, a food grade (GRAS) variant of gum Arabic or other similar binder. The slurry acts as a transport mechanism for the micro-capsules, easing their application to the material. Other liquids may be used for the slurry. The micro-capsule slurry may be stored in containers (e.g., five gallon plastic containers) for transportation to a printer and application as described below.

The visual design or printing ink is applied to the base or substrate material, block 108. The base or substrate material may be the material, product or packaging on which the scented material will be placed. The base or substrate material may be paper, cardboard or other material. For example, the base or substrate material may be the cardboard of a CD or DVD package. The visual design or printing may be applied using a four-color offset printing method. In the four-color offset printing method, the necessary colored inks to create the colors of the design and/or printing are applied.

With continuing reference to FIG. 1, the micro-encapsulated scented oil is applied as a varnish on top of the printed material. In an embodiment, the liquid medium with the micro-encapsulated scented oils is applied on top of the printed material, block 110. For example, the scented oil micro-capsule slurry may be applied on top of the visual design or printing ink. In an embodiment, the liquid medium is applied 110 immediately after the ink is applied 108 to the substrate material. In an embodiment, the printed material is rolled through a coater, e.g., an aquis-coater, which applies, e.g., sprays, the liquid medium with the scented micro-capsules onto the printed material. The coater may spray the slurry onto the printed material as a “flood coat.” A flood coat covers a portion or even the entire surface area of the printed material with the slurry; in affect, the printed material is flooded with the slurry. The coater, e.g., an Aquis coater, can be fed the slurry from a container (e.g., a five gallon plastic container) using a pump and an agitator.

In embodiments the temperature and other conditions of the liquid medium (e.g., the slurry), the environment, the coater and other machines used in the process are closely monitored to keep the viscosity at the right level. If the temperature gets too high, the liquid medium (e.g., the slurry) will become less viscous and may flow right off the printed material without the micro-capsules binding or adhering; if the temperature gets too low, the slurry will become more viscous and may clump, fail to flow evenly or otherwise not adhere smoothly to the printed material. One of ordinary skill in the art will be able to determine the appropriate temperature and other conditions, as well as the appropriate viscosity of the liquid medium (e.g., the slurry). Typically, room temperature is a good temperature for applying the liquid medium. Embodiments described herein use a sheet-fed printer, although flexographic and other printers will work as well.

With continuing reference to FIG. 1, after the liquid medium (e.g., the slurry) is applied, the scented, printed material is dried, block 112. In embodiments, the printed material is dried with a gentle heat (e.g., the scented, printed material is placed in an environment with elevated temperature, but without blown heat or ultraviolet). A gentle heat, e.g., room temperature to moderately above room temperature, is used to avoid activating or damaging the micro-capsules. Ultraviolet is avoided as it can drive off or reduce the scent. Drying in this manner typically takes four to six (4-6) hours.

Once dried, the scented, printed material is cut, folded and/or glued, or otherwise prepared for its intended use, as necessary, block 114. For example, the scented, printed material may be die cut, folded and glued in order to form a CD or DVD case. A plastic CD/DVD tray may be glued into the case formed from the cut, folded and glued scented, printed material. Other packaging or products may be formed from the scented, printed material. For example, advertising inserts, posters, coupons, product boxes and other packaging may be formed.

Embodiments of the scented, printed material are stored at ambient or colder temperature in order to keep the scented micro-capsules fresh and intact. Ideally, the scented, printed material is gently handled so as to avoid prematurely rupturing the micro-capsules and releasing the scent.

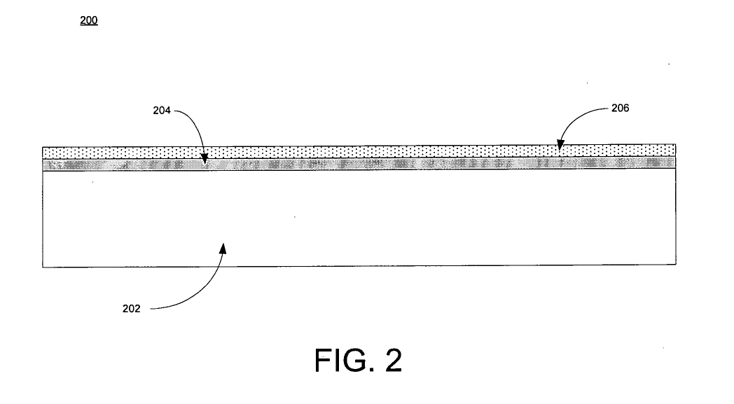

With reference now to FIG. 2, shown is a diagram illustrating a cross-sectional view of an embodiment of scented, printed material 200 prepared according to embodiments of the method described herein. The scented, printed material 200 includes a base or substrate material 202, in this case paper, a layer of ink 204 and a micro-capsule scented layer 206. The ink layer 204 is the print and/or design applied to the base material 202 for decorative or similar purposes. The micro-capsule scented layer 206 includes the scented oil micro-capsules and the binder or binding material applied via the slurry described herein. The binder binds the micro-capsules to the ink layer 204. The micro-capsules are released (i.e., ruptured) when touched with sufficient abrasive force, releasing the scented oil into the air, causing the desired scent to be smelled.

Although FIG. 2 depicts the scented layer 206 as only in direct contact with ink layer 204, scented layer 206 may be in direct contact with base or substrate material 202. For example, ink layer 204 may not cover entire surface of base or substrate material 202. Likewise, scented layer 206 may be applied on non-printed material that does not include an ink layer 204. In other words, FIG. 2 is illustrative.

The terms and descriptions used herein are set forth by way of illustration only and are not meant as limitations. Those skilled in the art will recognize that many variations are possible within the spirit and scope of the invention as defined in the following claims, and their equivalents, in which all terms are to be understood in their broadest possible sense unless otherwise indicated.

1. A method for manufacturing scented material, comprising:
micro-encapsulating one or more scented oils;
suspending the micro-encapsulated one or more scented oils into a liquid medium;
applying ink to the material, wherein an ink layer is formed on the material; and
applying the liquid medium with the suspended micro-encapsulated one or more scented oils to the material on top of the ink layer, wherein a scented layer is formed above the ink layer on the material.

2. The method of claim 1 further comprising drying the material, wherein the scented layer and ink layer are dried.

3. The method of claim 2 wherein drying the material includes drying the material with a gentle heat.

4. The method of claim 2 wherein drying the material takes four to six hours.

5. The method of claim 2 further comprising preparing the scented material for an intended use.

6. The method of claim 5 wherein preparing the scented material includes cutting the scented material.

7. The method of claim 5 wherein preparing the scented material includes folding the scented material.

8. The method of claim 5 wherein preparing the scented material prepares the scented material for use as a CD or a DVD case.

9. The method of claim 1 wherein applying ink to the material includes applying a plurality of inks to print a design on the material.

10. The method of claim 1 wherein applying ink to the material includes printing text on the material.

11. The method of claim 1 wherein the liquid medium is a slurry.

12. The method of claim 11 wherein slurry includes a binder that binds to the micro-encapsulated one or more scented oils

13. The method of claim 1 wherein the material is paper or cardboard.

14. The method of claim 1 further comprising selecting the one or more scented oils to use for scenting a material.

15. A method for manufacturing scented material, comprising:
micro-encapsulating the selected one or more scented oils, wherein a plurality of scented oil micro-capsules are formed, the micro-capsules containing scented oil;
applying ink to the material, wherein an ink layer is formed on the material;
applying the micro-capsules to the material on top of the ink layer, wherein a scented layer is formed above the ink layer on the material;
drying the material, wherein the scented layer and ink layer are dried; and
preparing the scented material for an intended use.

16. The method of claim 15 wherein preparing the scented material prepares the scented material for use as a CD or a DVD case.

17. The method of claim 15 wherein applying ink to the material includes applying a plurality of inks to print a design on the material.

18. The method of claim 15 wherein applying ink to the material includes printing text on the material.

19. The method of claim 15 further comprising selecting one or more scented oils to use for scenting a material.

20. A method for manufacturing scented CD or DVD cases, comprising:
micro-encapsulating the selected one or more scented oils, wherein a plurality of scented oil micro-capsules are formed, the micro-capsules containing scented oil;
applying ink to the material, wherein an ink layer is formed on the material;
applying the micro-capsules to the material on top of the ink layer, wherein a scented layer is formed above the ink layer on the material;
drying the material, wherein the scented layer and ink layer are dried; and
preparing the scented material for use as a CD or DVD case.
